(19) United States
(12) Patent Application Publication
(10) Pub. No.: US 2022/0001559 A1
(43) Pub. Date: Jan. 6, 2022

(54) GROOMING DEVICE WITH LOAD SENSING IN NECK

(71) Applicant: The Gillette Company LLC, Boston, MA (US)

(72) Inventors: Alexander Hiller, Kronberg (DE); Judith Von Dahlen, Frankfurt (DE); Dominik Jueling, Schmitten (DE); Aliaksandr Andrasiuk, Nordrhein-Westfalen (DE); Jan Christian Langsdorf, Kronberg (DE); Ian Anthony Good, Reading (GB)

(21) Appl. No.: 16/920,304

(22) Filed: Jul. 2, 2020

(51) Int. Cl. B26B 21/40; B26B 21/22; B26B 21/52

(52) U.S. Cl. CPC B26B 21/4056; B26B 21/526; B26B 21/22; B26B 21/4062

(57) ABSTRACT

A grooming device. The grooming device includes a handle having a neck portion, a displacement sensor positioned within the neck portion, a housing portion, a coupling mechanism securing the neck portion and the housing portion to one another, and a power source positioned within the handle. The neck portion includes a proximal end and a distal end. The proximal end of the neck portion having an implement connecting structure. The housing portion includes a proximal end, a distal end, and a location element. The proximal end of the housing portion is pivotably connected to the distal end of the neck portion about a handle pivot axis. As the neck portion pivots about the handle pivot axis relative to the housing portion, the displacement sensor detects displacement of the location element. A grooming implement is connected to the implement connecting structure.

### FIELD OF THE INVENTION

The present invention relates to a grooming device, and more particularly to a grooming device having the ability to improve the usage experience of the grooming device by providing information about the usage experience to the user related to the grooming device.

### BACKGROUND OF THE INVENTION

There are numerous grooming devices used by consumers every day. Proper usage techniques of such grooming devices facilitate the overall efficacy of the product providing the user with a more positive experience than he or she would have otherwise experienced. Such positive usage experiences will likely lead to continued product usage. Providing the user with information about proper usage techniques for using grooming devices appliance has been limited.

Razors with sensors have been used to provide information to the user. Razors with proximity sensors or cameras have been used to provide information on blade attrition. Razors with force sensors have been used to provide the user with information on the amount of force being applied to the skin. By tracking the force being applied during the shave provide a metric to gauge blade dulling and predict blade attrition. Razors having sensors to count shaving strokes have been used to again assist with blade attrition. Cameras have been used to provide users with boundary indicators such as distinguishing between areas of long hair such as sideburns adjacent to areas of shorter hair length.

To date the devices providing force and blade life tracking have been limited in their commercial viability given the complicated designs. There is a desire to provide a grooming device with force indication and blade life tracking in a simple design. Such a design has yet to be provided.

### SUMMARY OF THE INVENTION

The present invention relates to a grooming device. The grooming device includes a handle and a grooming implement. The handle includes a neck portion, a displacement sensor, a housing portion, and a power source positioned within the handle. The neck portion includes a proximal end and a distal end where the proximal end of the neck portion has an implement connecting structure. The displacement sensor is positioned within the neck portion. The housing portion comprises a proximal end, a distal end, and a location element. The proximal end of the housing portion is pivotably connected to the distal end of the neck portion about a handle pivot axis. As the neck portion pivots about the handle pivot axis relative to the housing portion, the displacement sensor detects displacement of the location element. The power source provides power to the displacement sensor. The grooming implement is connected to the implement connecting structure.

The location element can be positioned adjacent the proximal end of the housing portion.

The displacement sensor can be position adjacent the distal end of the neck portion.

The grooming device may further comprise a spring positioned between the neck portion and the housing portion.

The grooming device may comprise an electric shaver, a shaving razor, and/or an epilator.

An algorithm may calculate a load being placed on the grooming implement based on displacement of the location element.

The handle may further comprise a feedback mechanism.

The feedback mechanism may comprise a visual indicator, an LED, a vibration mechanism, and/or an audio mechanism.

The feedback mechanism may indicate a pressure or a load state.

The handle may further comprise an eject button to eject the grooming implement from the handle. The location element may be displaced upon depression of the ejection button providing an indication that the grooming implement has been ejected.

The eject button may comprise a second location element. The second location element being displaced upon activation of the ejection button providing an indication that the grooming implement has been ejected.

The displacement sensor may comprise a magnetic sensor, an optical sensor, a capacitive sensor, an inductive sensor, a resistive sensor, a conductive sensor, a proximity sensor, an electrical switch, a mechanical switch, an electromechanical switch, or an electromagnetic switch.

The location element may comprise a magnet, a visual marker, a physical marker, a metal, a plastic or an electrically conductive material.

The handle may further comprise a second displacement sensor.

The distal end of the neck portion can be pivotably connected to the proximal end of the housing portion by a hinge.

The hinge may comprise an elastomer, a plastic material, a pin, or a metal.

The housing portion may further comprise a memory storage device.

The housing portion may further comprise a communication device.

The communication device may communicate with a second device.

The housing portion may be watertight.

The handle may further comprise an electrical connection between the neck portion and the housing portion of the handle.

The electrical connection between the neck portion and the housing portion comprises a printed circuit board.

The printed circuit board may include a first section at least partially disposed within the housing portion and a second section extending to or through the neck portion.

The printed circuit board may couple the power source and the displacement sensor.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designation substantially identical elements, and in which:

FIG. 1 is a side perspective view of a grooming device constructed in accordance with the teachings of the present disclosure and a second device.

FIG. 2 is a top down, detailed view of a portion of the grooming device of FIG. 1.

FIG. 3A is a side plan view of the portion of the grooming device of FIG. 2 with the handle pivot axis in a first position.

FIG. 3B is a side plan view of the portion of the grooming device of FIG. 2 with the handle pivot axis in a second position.

FIG. 4A is a block diagram of a grooming device with a feedback mechanism positioned in a first location and the handle pivot axis in a first position.

FIG. 4B is a block diagram of a grooming device with a feedback mechanism positioned in a first location and the handle pivot axis in a second position.

FIG. 5A is a block diagram of a grooming device with a feedback mechanism positioned in a second location and the handle pivot axis in a first position.

FIG. 5B is a block diagram of a grooming device with a feedback mechanism positioned in a second location and the handle pivot axis in a second position.

FIG. 6 is a plan diagram of the collected shave data and associated algorithms.

### DETAILED DESCRIPTION OF THE INVENTION

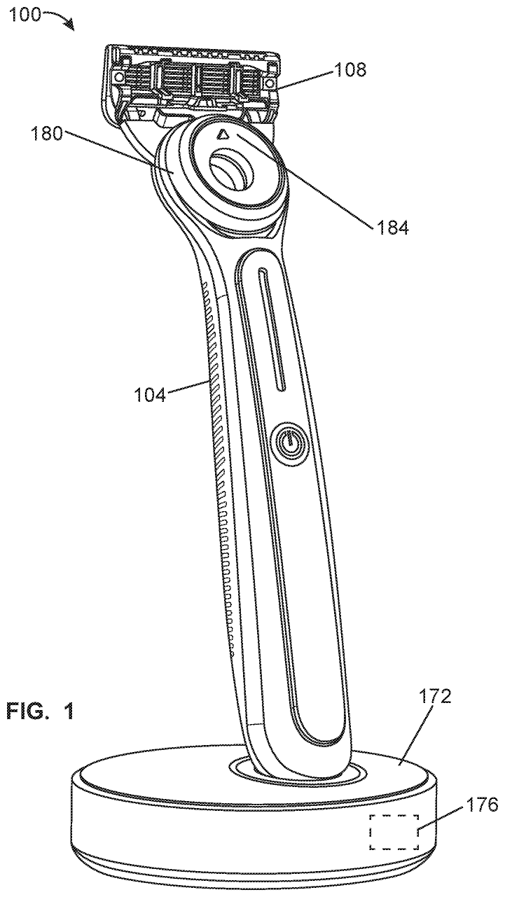

Referring now to FIG. 1, there is shown a grooming device 100. The grooming device 100 shown is a shaving razor. The shaving razor is just one example of a grooming device of the present invention. Examples of other grooming devices of the present invention include an electric shaver, and an epilator. The grooming device 100 includes a handle 104 and a grooming implement 108 removably connected to the handle 104. The grooming implement 108 shown is a razor cartridge that includes one or more blades for cutting hair.

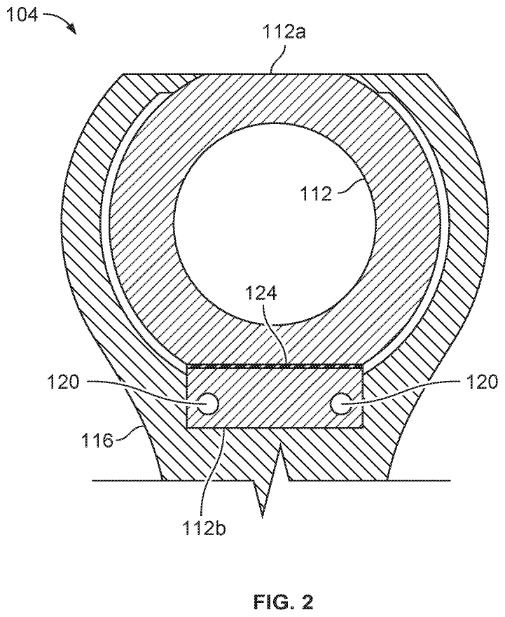

FIG. 2 illustrates a detailed view of a portion of the handle 104 of the grooming device 100 shown in FIG. 1. In particular, the handle 104 includes a neck portion 112 that is coupled to a housing portion 116. The neck portion 112 is illustrated as a distinct component and is not integrally formed with the housing portion 116. The housing portion 116 and neck portion 112 may also be integrally formed as a single component. Accordingly, the handle 104 includes one or more coupling mechanisms 120 that couple the neck portion 112 and the housing portion 116 to one another. As illustrated in FIG. 2, the coupling mechanism 120 is a plate that includes a plurality of cylindrical rivet type securement mechanisms. While coupling mechanism 120 is illustrated as a single component shaped to allow passage of electronic components from the housing portion 116 to the neck portion 112, the coupling mechanism 120 may also be divided into two or more distinct components.

The neck portion 112 moves relative to the housing portion 116 about a handle pivot axis 124 when a load is applied to the grooming implement 108. As illustrated, the coupling mechanism 120 forms a rigid connection between the neck portion 112 and the housing portion 116, and the handle pivot axis 124 is formed by an integrated live-hinge feature positioned at the distal end of the neck portion 112. The handle pivot axis 124 may also be formed as part of the coupling mechanism 120 between the neck portion 112 and the housing portion 116 using, for example, a pin joint or a flexible beam member that allows displacement between the housing portion 116 and the neck portion 112. There may also be a spring component located between the neck portion 112 and the housing portion 116 that provides a return force causing the neck portion 112 to return to a rest position after being displaced.

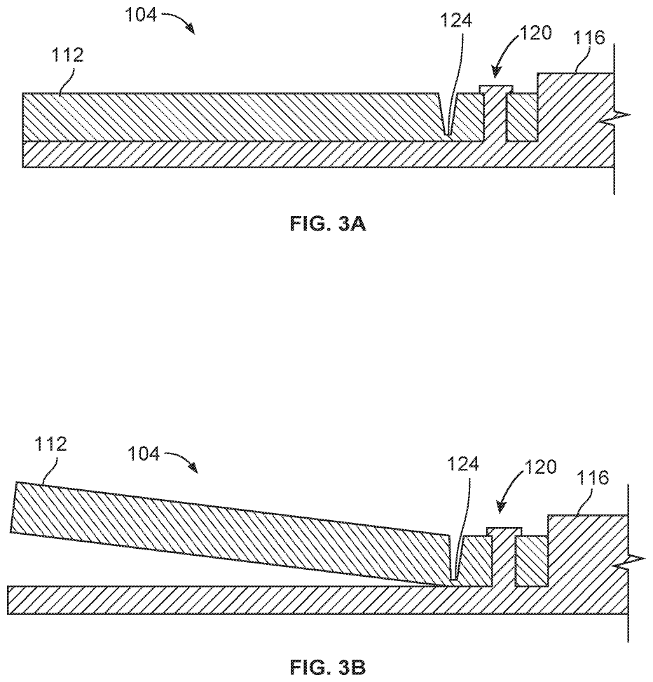

Referring now to FIGS. 3A and 3B, which illustrate a portion of the handle 104 of the grooming device 100 showing in a first position (FIG. 3A) and in a second position (FIG. 3B). As a load is applied to the grooming implement 108 of the grooming device 100, the neck portion 112 may pivot relative to the housing portion 116. In the first position (FIG. 3A), the neck portion 112 and the housing portion 116 are not displaced relative to one another because a load or a force is not acting on the grooming implement 108 of the grooming device 100. Accordingly, in the first position, the neck portion 112 remains substantially flat. In the second position (FIG. 3B), the neck portion 112 is displaced relative to the housing portion 116 because a load or force is acting on the grooming implement 108 of the grooming device 100. As the neck portion 112 experiences a load or force, the neck portion 112 rotates about a handle pivot axis 124.

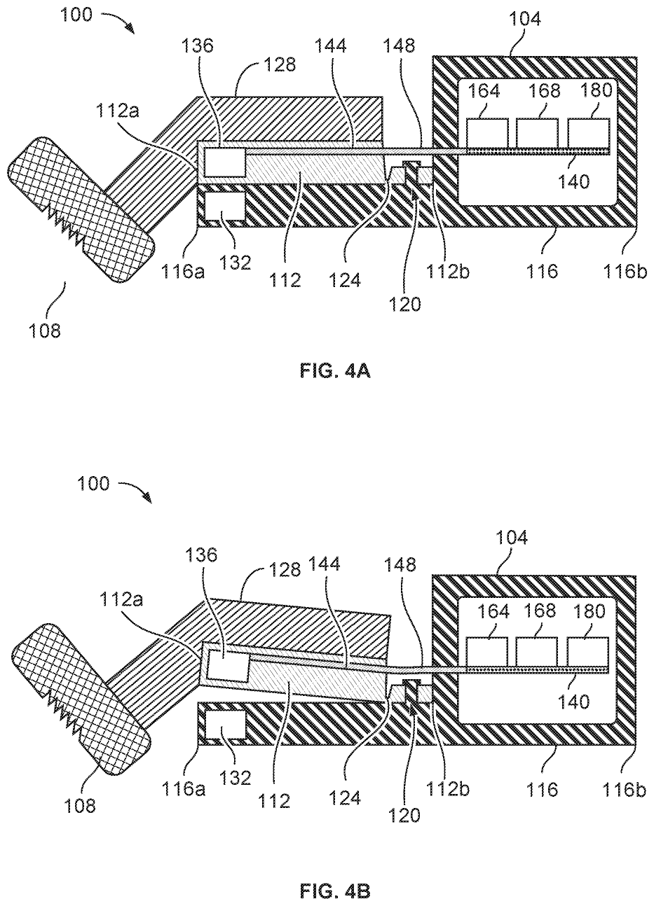

Turning now to FIGS. 4A and 4B, which illustrate a block diagram of the handle 104, an implement connecting structure 128, and the grooming implement 108. The handle 104 includes the housing portion 116 and the neck portion 112 that is coupled to the housing portion 116 by the coupling mechanism 120. The housing portion 116 includes a proximal end 116a and a distal end 116b. A power source 164 may be positioned within the housing portion 116. The power source 164 provides power to displacement sensor 136 and to other sensors and other devices needing power. The power source 164 may comprise a rechargeable battery, a disposable battery, or a corded electrical connection. A location element 132 is positioned within the housing portion 116. In particular, the location element 132 is positioned within the housing portion 116 adjacent the proximal end 116a of the housing portion 116. The location element 132 may be a magnet, a visual marker, a physical marker, a metal, a plastic or an electrically conductive material.

The neck portion 112 includes a proximal end 112a, a distal end 112b, and a displacement sensor 136 positioned between the proximal and distal ends 112a, 112b. The proximal end 112a of the neck portion 112 comprises an implement connecting structure 128. The distal end 112b of the neck portion 112 is pivotably connected to the housing portion 116 via the coupling mechanism 120 and rotates about the handle pivot axis 124. An electrical connection is formed between the housing portion 116 of the handle 104 and the neck portion 112 of the handle 104. In particular, as illustrated in FIGS. 4A and 4B, the electrical connection includes a handle printed circuit board (“PCB”) 140 disposed in the housing portion 116 and a flexible PCB 144 coupled to the handle PCB 140 and extending from the handle PCB 140 through the neck portion 112 to the displacement sensor 136. As a result, the flexible PCB 144 includes a bending section 148 disposed between the neck portion 112 and the housing portion 116.

The displacement sensor 136 is positioned on the flexible PCB 144 on the neck portion 112 side of bending section 148. So configured, as the neck portion 112 rotates about the handle pivot axis 124, the location element 132 remains stationary while the displacement sensor 136 rotates with the neck portion 112 (FIG. 3B and FIG. 4B). Accordingly, the displacement sensor 136 moves away or toward the location element 132 in proportion to the load applied to grooming implement 108. As the displacement sensor 136 moves away from the location element 132, there is a reduction in the signal strength from the location element 132 to the displacement sensor 136. The data (e.g., signal strength) from the displacement sensor 136 can be analyzed to identify a grooming event, which is characterized by a momentary negative spike, or reduction, in the signal strength as the displacement sensor 136 moves away from the location element 132. The displacement sensor 136 may be a magnetic sensor, an optical sensor, a capacitive sensor, an inductive sensor, a resistive sensor, a conductive sensor, a proximity sensor, an electrical switch, a mechanical switch, an electromechanical switch, or an electromagnetic switch.

The grooming device 100 may include a feedback mechanism 180 which may be positioned in the housing portion 116 (FIGS. 4A and 4B) or on a second device 172 (FIG. 1). The feedback mechanism 180 provides the user with information about the grooming experience. The feedback mechanism 180 may be a visual indicator such as an LED or LCD display. The feedback mechanism 180 may be a vibration mechanism and/or an audio mechanism. A single feedback mechanism or multiple feedback mechanisms may be used depending on the desired communication with the user. The feedback mechanism 180 may indicate a pressure or load state or other relevant information derived from displacement sensor 136. For example, the feedback mechanism 180 may be an LED which shows a green color for grooming with a proper pressure or load and a red color for grooming above a proper pressure or load state.

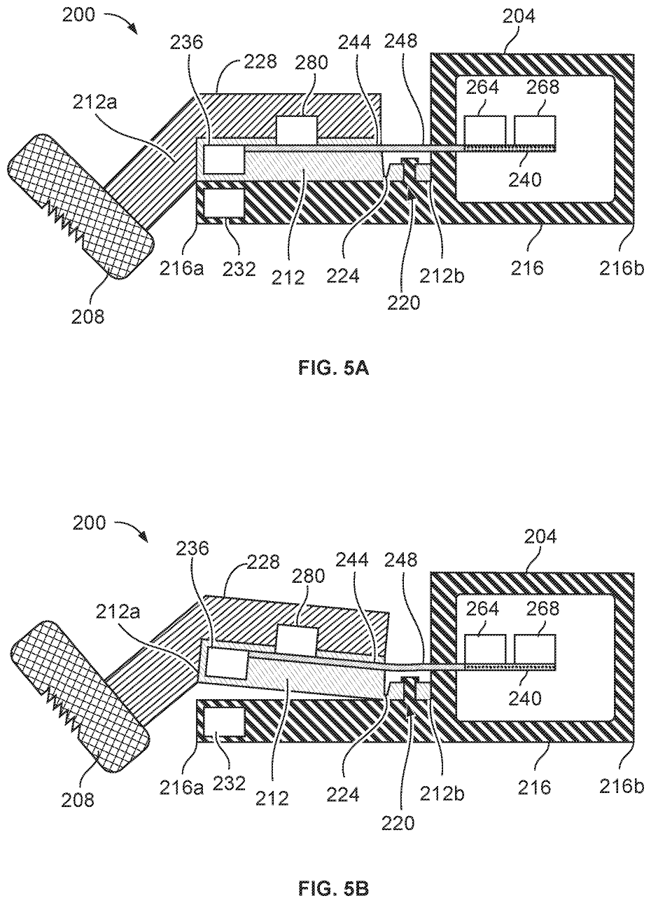

FIGS. 5A and 5B illustrate another example block diagram of a handle 204, an implement connecting structure 228, and a grooming implement 208. The block diagram of FIGS. 5A and 5B is similar to the block diagram of FIGS. 4A and 4B, except the block diagram of FIGS. 5A and 5B illustrate another example placement of a feedback mechanism 280. Thus, for ease of reference, and to the extent possible, the same or similar components of the block diagram of FIGS. 5A and 5B will retain the same reference numbers, although the reference numbers will be increased by 100.

The handle 204 includes the housing portion 216 and the neck portion 212 that is coupled to the housing portion 216 by the coupling mechanism 220. The housing portion 216 includes a proximal end 216a and a distal end 216b. A power source 264 may be positioned within the housing portion 216. The power source 264 provides power to displacement sensor 236 and to other sensors and other devices needing power. The power source 264 may comprise a rechargeable battery, a disposable battery, or a corded electrical connection. A location element 232 is positioned within the housing portion 216. In particular, the location element 232 is positioned within the housing portion 216 adjacent the proximal end 216a of the housing portion 216. The location element 232 may be a magnet, a visual marker, a physical marker, a metal, a plastic, or an electrically conductive material.

The neck portion 212 includes a proximal end 212a, a distal end 212b, and a displacement sensor 236 positioned between the proximal and distal ends 212a, 212b. The proximal end 212a of the neck portion 212 comprises an implement connecting structure 228. The distal end 212b of the neck portion 212 is pivotably connected to the housing portion 216 via the coupling mechanism 220 and rotates about the handle pivot axis 224. An electrical connection is formed between the housing portion 216 of the handle 204 and the neck portion 212 of the handle 204. In particular, as illustrated in FIGS. 5A and 5B, the electrical connection includes a handle printed circuit board (“PCB”) 240 disposed in the housing portion 216 and a flexible PCB 244 coupled to the handle PCB 240 and extending from the handle PCB 240 through the neck portion 212 to the displacement sensor 236. As a result, the flexible PCB 244 includes a bending section 248 disposed between the neck portion 212 and the housing portion 216.

The displacement sensor 236 is positioned on the flexible PCB 244 on the neck portion 212 side of bending section 248. So configured, as the neck portion 212 rotates about the handle pivot axis 224, the location element 232 remains stationary while the displacement sensor 236 rotates with the neck portion 212 (FIG. 3B and FIG. 5B). Accordingly, the displacement sensor 236 moves away or toward the location element 232 in proportion to the load applied to grooming implement 208. As the displacement sensor 236 moves away from the location element 232, there is a reduction in the signal strength from the location element 232 to the displacement sensor 236. The data (e.g., signal strength) from the displacement sensor 236 can be analyzed to identify a grooming event, which is characterized by a momentary negative spike, or reduction, in the signal strength as the displacement sensor 236 moves away from the location element 232. The displacement sensor 236 may be a magnetic sensor, an optical sensor, a capacitive sensor, an inductive sensor, a resistive sensor, a conductive sensor, a proximity sensor, an electrical switch, a mechanical switch, an electromechanical switch, or an electromagnetic switch.

The grooming device 200 may include a feedback mechanism 280 which may be positioned in in the neck potion 212 (FIG. 5) or on the second device 172 (FIG. 1). The feedback mechanism 280 provides the user with information about the grooming experience. The feedback mechanism 280 may be a visual indicator such as an LED or LCD display. The feedback mechanism 280 may be a vibration mechanism and/or an audio mechanism. A single feedback mechanism or multiple feedback mechanisms may be used depending on the desired communication with the user. The feedback mechanism 280 may indicate a pressure or load state or other relevant information derived from displacement sensor 236. For example, the feedback mechanism 280 may be an LED which shows a green color for grooming with a proper pressure or load and a red color for grooming above a proper pressure or load state.

Preferably the housing portion 116 is watertight thus allowing the grooming device 100 to be used in wet conditions while protecting the power source 164 and any other sensors or electronic components within the housing portion 116. The neck portion 112 or the flexible PCB 144 may also be watertight to protect the displacement sensor 136, 236, the feedback mechanism 280 and any other sensors or electronic components within the neck portion 112, 212 or connected to the flexible PCB 144, 244.

The grooming device 100 may include a communication device 168 positioned within the housing portion 116. The communication device 168 may be a wireless connection, a wired connection, a removable memory card, a vibration device, microphone, an audio device, and/or a visual indicator such as an LED or LCD display. The communication device 168 allows the grooming device 100 to communicate with a user and/or a second device 172 (FIG. 1). The second device 172 includes a second communication device 176 that can communicate with the communication device 168 of the grooming device 100. Communication with the second device 172 may be wirelessly through a cloud architecture and wirelessly to the second device 172. The second device 172 may be a mobile phone, a computer application, a computer, an electronic device, or a base for holding the grooming device 100.

In use, the user will grasp the housing portion 116 of the handle 104. The power source 164 will power up and power the sensors needing power. The power source 164 may power up automatically upon contact with or movement by the user. In some examples, the power source 164 can power up via an on/off switch. In other examples, the power source 164 can be constantly on and preferably in a power save mode while not in use and then in full power mode when in use. The user will then groom.

As the user grooms, data (e.g., signal strength) is collected from the displacement sensor 136. The data collected can be used to calculate the pressure and/or load on the handle 104 as well as contact data. The data collected may also be used to calculate the number and length of each grooming stroke experienced and the total distance or mileage the grooming implement 108 has experienced at any given point in time. When the user is finished grooming, the grooming device 100 is put down and data collection stops. The collected data may be transmitted instantaneously as the data is collected via the communication device 168. In other examples, the collected data is transmitted after the data from a single grooming event or multiple grooming events has been collected via the communication device 168. The data, whether transmitted instantaneously or after a period of time, can be transmitted through the feedback mechanism 180.

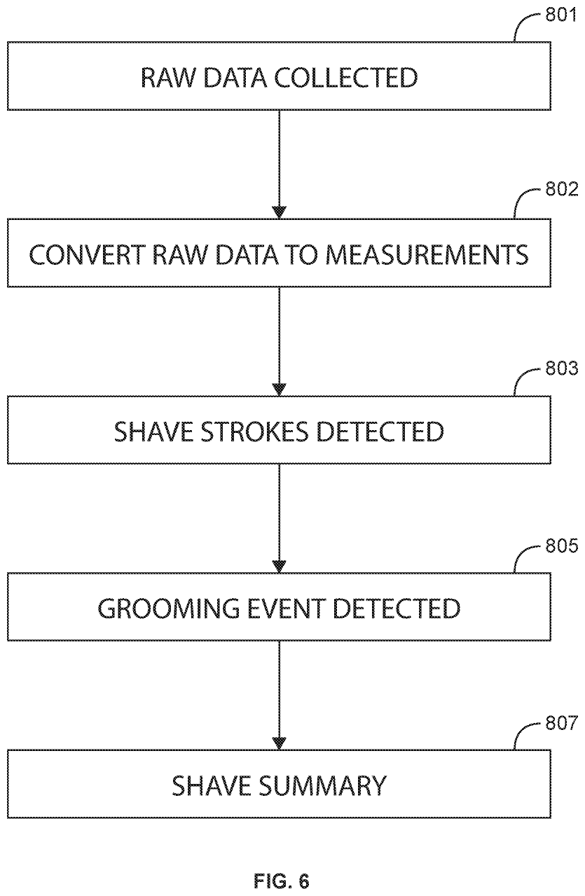

Referring now to FIG. 6, there is shown a plan diagram of the collected data and algorithms used with the grooming device. With the power source on, raw data is collected (step 801) during the grooming event from the displacement sensor 136. The raw data is then converted into measurements (step 802). The measurements may be made by a logic device such as, for example, a microprocessor. The logic device may be located within the housing portion 116 of the handle 104. Alternatively, the raw data can be sent from the communication device 168 to the second device 172 such as a mobile phone, a computer application, a computer, or an electronic device where measurements may be made by a logic device such as, for example, a microprocessor. Individual shave stroke events are detected (step 803) from the raw data of the displacement sensor using an algorithm. As the magnitude of displacement between the displacement sensor 136 and the location element 132 increases, there is a proportional relationship between the displacement and the load being applied to the grooming implement 108. The algorithm calculates the load applied to the grooming implement 108 based on the displacement of location element 132 from the displacement sensor 136. The algorithm may be pre-programmed or, in other examples, can be a sensor-based learning model, which may be an artificial intelligence-based model (e.g., a machine learning model) trained on displacement data. A machine learning imaging model may be trained using a supervised or unsupervised machine learning program or algorithm. The machine learning program or algorithm may employ a neural network, which may be a convolutional neural network, a deep learning neural network, or a combined learning module or program that learns in one or more features or feature datasets. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

The algorithm may monitor the magnitude of the displacement between the displacement sensor 136 and the location element 132 detected by the displacement sensor 136 from a known baseline. For example, if a user starts shaving there would be an activation of the displacement sensor 136 when the grooming implement 108 touches the skin on the user's face causing the neck portion 112 to pivot. If a predetermined number of shave stroke events are detected within a predetermined period of time associated with device activation, then the session will be classified as a grooming event (step 805).

A summary of the shave may be generated from a combination of steps 802, 803, and 805 (step 807) and can be communicated to the user via the feedback mechanism 180 or communicated to the second device 172 via the communication device 168. Step 807 may also be used in conjunction with user profile data collected directly from the user to add an extra level of context such as, for example, how the new shave event compares to previous shave events or to the user's personal shave goals.

The grooming device 100 may have additional motion sensors to detect device movements such as, for example, an accelerometer, a gyroscope, or a magnetometer. Movement data can be processed in conjunction with displacement data via a sensor-based learning model in order to determine stroke parameters such as the stroke direction or location on the body. Additionally, stroke parameter data can be used in conjunction with user profile data to add an extra level of context such whether a stroke direction was with or against the direction of the user's hair growth.

As illustrated in FIG. 1, the grooming device 100 may include an eject button 184. As a user activates the eject button 184, the grooming implement 108 is ejected from handle 104. Activation of the eject button 184 causes a displacement of the displacement sensor 136 relative to the location element 132. In particular, the displacement sensor 136 moves in a direction that is different from the direction of displacement caused by a load being applied to the grooming implement 108. An eject event can therefore be detected as a ‘negative’ displacement in the displacement data. In some examples, the eject button 184 can contain a second location element detectable by the displacement sensor 136. Activation of the eject button 184 can cause a displacement of the second location element relative to displacement sensor 136, which may have a different direction or magnitude of displacement than the direction of displacement caused by a load being applied to the grooming implement 108. Additionally, the grooming device 100 may include a dedicated grooming implement replacement sensor separate from the displacement sensor 136.

An example is below:

A. A grooming device comprising:
a. a handle comprising;
   i. a neck portion comprising a proximal end and a distal end, the proximal end of the neck portion comprising an implement connecting structure;
   ii. a displacement sensor positioned within the neck portion;
   iii. a housing portion comprising a proximal end, a distal end and a location element, the proximal end of the housing portion being pivotably connected to the distal end of the neck portion about a handle pivot axis, as the neck portion pivots about the handle pivot axis relative to the housing portion the, displacement sensor detects displacement of the location element;
   iv. a coupling mechanism securing the neck portion and the housing portion to one another;
   v. a power source positioned within the handle, the power source providing power to the displacement sensor; and
b. a grooming implement connected to the implement connecting structure.

B. The grooming device of paragraph A, wherein the location element is positioned adjacent the proximal end of the housing portion.

C. The grooming device of paragraph A, wherein the displacement sensor is positioned adjacent the proximal end of the neck portion.

D. The grooming device of paragraph A, wherein the displacement sensor comprises a magnetic sensor, an optical sensor, a capacitive sensor, an inductive sensor, a resistive sensor, a conductive sensor, a proximity sensor, an electrical switch, a mechanical switch, an electromechanical switch, or an electromagnetic switch.

E. The grooming device of paragraph A, wherein the location element comprises a magnet, a visual marker, a physical marker, a metal, a plastic, or an electrically conductive material.

F. The grooming device of paragraph A, wherein the distal end of the neck portion is pivotably connected to the proximal end of the first portion by a hinge.

G. The grooming device of paragraph F, wherein the hinge comprises an elastomer, a plastic material, a pin, or a metal.

H. The grooming device of paragraph A, further comprising a spring positioned between the neck portion and the housing portion.

I. The grooming device of paragraph A, wherein the housing portion is watertight.

J. The grooming device of paragraph A, wherein the handle further comprises an electrical connection between the neck portion and the housing portion.

K. The grooming device of paragraph J, wherein the electrical connection between the neck portion and the housing portion comprises a printed circuit board.

L. The grooming device of paragraph K, wherein the printed circuit board includes a first section at least partially disposed within the housing portion and a second section extending to or through the neck portion.

M. The grooming device of paragraph K, wherein the printed circuit board couples the power source and the displacement sensor.

N. The grooming device of paragraph K, wherein the printed circuit board is watertight.

O. The grooming device of paragraph A, further comprising one or more feedback mechanisms positioned in the handle.

P. The grooming device of paragraph O, wherein the feedback mechanism is positioned in the housing portion.

Q. The grooming device of paragraph O, wherein the feedback mechanism is positioned in the neck portion.

R. The grooming device of paragraph O, wherein the feedback mechanism comprises a visual indicator, an LED, a vibration mechanism, and/or an audio mechanism.

S. The grooming device of paragraph O, wherein the feedback mechanism indicates a pressure, a load state, a shave stroke state, or a grooming implement state.

T. The grooming device of paragraph A, further comprising an eject button configured to eject the grooming implement from the handle.

U. The grooming device of paragraph T, wherein upon activation of the eject button, the displacement sensor is displaced thereby providing an indication that the grooming implement has been ejected.

V. The grooming device of paragraph T, wherein the eject button comprises a second location element, the second location element being displaced upon activation of the eject button thereby providing an indication that the grooming implement has been ejected.

W. The grooming device of paragraph A, further comprising a grooming implement replacement sensor positioned within the handle.

X. The grooming device of paragraph A, further comprising a communication device positioned within the handle.

Y. The grooming device of paragraph X, wherein the communication device communicates with a second device.

Z. The grooming device of paragraph A, further comprising one or more movement sensors positioned within the handle.

AA. The grooming device of paragraph A, further comprising a second displacement sensor positioned within the housing portion.

BB. The grooming device of paragraph A, further comprising a memory storage device positioned within the housing portion.

CC. The grooming device of paragraph A, wherein an algorithm calculates a load being placed on the grooming implement based on displacement of the location element.

The grooming device of paragraph A, wherein the grooming device comprises an electric shaver, a shaving razor, and/or an epilator.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A grooming device comprising:
a. a handle comprising:
i. a neck portion comprising a proximal end and a distal end, the proximal end of the neck portion comprising an implement connecting structure;
ii. a displacement sensor positioned within the neck portion;
iii. a housing portion comprising a proximal end, a distal end and a location element, the proximal end of the housing portion being pivotably connected to the distal end of the neck portion about a handle pivot axis, as the neck portion pivots about the handle pivot axis relative to the housing portion the, displacement sensor detects displacement of the location element;
iv. a coupling mechanism securing the neck portion and the housing portion to one another;
v. a power source positioned within the handle, the power source providing power to the displacement sensor; and
b. a grooming implement connected to the implement connecting structure.

2. The grooming device of claim 1, wherein the location element is positioned adjacent the proximal end of the housing portion.

3. The grooming device of claim 1, wherein the displacement sensor is positioned adjacent the proximal end of the neck portion.

4. The grooming device of claim 1, wherein the displacement sensor comprises a magnetic sensor, an optical sensor, a capacitive sensor, an inductive sensor, a resistive sensor, a conductive sensor, a proximity sensor, an electrical switch, a mechanical switch, an electromechanical switch, or an electromagnetic switch.

5. The grooming device of claim 1, wherein the location element comprises a magnet, a visual marker, a physical marker, a metal, a plastic, or an electrically conductive material.

6. The grooming device of claim 1, wherein the distal end of the neck portion is pivotably connected to the proximal end of the housing portion by a hinge.

7. The grooming device of claim 6, wherein the hinge comprises an elastomer, a plastic material, a pin, or a metal.

8. The grooming device of claim 1, further comprising a spring positioned between the neck portion and the housing portion.

9. The grooming device of claim 1, wherein the housing portion is watertight.

10. The grooming device of claim 1, wherein the handle further comprises an electrical connection between the neck portion and the housing portion.

11. The grooming device of claim 10, wherein the electrical connection between the neck portion and the housing portion comprises a printed circuit board.

12. The grooming device of claim 11, wherein the printed circuit board includes a first section at least partially disposed within the housing portion and a second section extending to or through the neck portion.

13. The grooming device of claim 11, wherein the printed circuit board couples the power source and the displacement sensor.

14. The grooming device of claim 11, wherein the printed circuit board is watertight.

15. The grooming device of claim 1, further comprising one or more feedback mechanisms positioned in the handle.

16. The grooming device of claim 15, wherein the feedback mechanism is positioned in the housing portion.

17. The grooming device of claim 15, wherein the feedback mechanism is positioned in the neck portion.

18. The grooming device of claim 15, wherein the feedback mechanism comprises a visual indicator, an LED, a vibration mechanism, and/or an audio mechanism.

19. The grooming device of claim 15, wherein the feedback mechanism indicates a pressure state, a load state, a shave stroke state, or a grooming implement state.

20. The grooming device of claim 1, the grooming device further comprising an eject button configured to eject the grooming implement from the handle.

21. The grooming device of claim 21, wherein, upon activation of the eject button, the displacement sensor is displaced thereby providing an indication that the grooming implement has been ejected.

22. The grooming device of claim 21, wherein the eject button comprises a second location element, the second location element being displaced upon activation of the eject button thereby providing an indication that the grooming implement has been ejected.

23. The grooming device of claim 1, further comprising a grooming implement replacement sensor positioned within the handle.

24. The grooming device of claim 1, further comprising a communication device positioned within the handle.

25. The grooming device of claim 24, wherein the communication device is configured to communicate with a second device.

26. The grooming device of claim 1, further comprising one or more movement sensors positioned within the handle.

27. The grooming device of claim 1, further comprising a second displacement sensor positioned within the housing portion.

28. The grooming device of claim 1, further comprising a memory storage device positioned within the housing portion.

29. The grooming device of claim 1, wherein an algorithm calculates a load being placed on the grooming implement based on displacement of the location element.

30. The grooming device of claim 1, wherein the grooming device comprises an electric shaver, a shaving razor and/or an epilator.
